(19) United States
(12) Patent Application Publication
(10) Pub. No.: US 2016/0339604 A1
(43) Pub. Date: Nov. 24, 2016

(54) METHOD AND DEVICE FOR PRODUCING THIN-WALLED PLASTIC PROFILES

(71) Applicant: THOMAS GMBH + CO. TECHNIK + INNOVATION KG, Bremervörde (DE)

(72) Inventor: Klaus Jansen, Buxtehude (DE)

(73) Assignee: THOMAS GMBH + CO. TECHNIK + INNOVATION KG, Bremervörde (DE)

(21) Appl. No.: 15/112,547

(22) PCT Filed: Jan. 7, 2015
(86) PCT No.: PCT/EP2015/000014

§ 371 Date: Jul. 19, 2016

(30) Foreign Application Priority Data
Jan. 30, 2014 (DE) 10 2014 001 082.1

(51) Int. Cl. B29B 11/16

(52) U.S. Cl. CPC B29B 11/16; B29K 2105/08

(57) ABSTRACT

A method and device in which at least part of a mold is moved periodically relative to the stationary thin-walled plastic profile and the thin-walled plastic profile is held by at least one holding means or gripper, which comprises a core and an outer holding part, whilst the mold is moved along the thin-walled plastic profile, which is stationary relative to said mold. Plastic material objects, in particular plastic profiles, are produced predominantly in a strand, preferably using the pultrusion method. In this case, the plastic profile is pulled through a mold. As a result of the plastic profile being pulled through the mold by a take-off device, it is only possible to form plastic profiles which withstand the force or the pressing pressure of the take-off device. Consequently, only plastic profiles which comprise sufficient wall thicknesses have been producible up to now.

### STATEMENT OF RELATED APPLICATIONS

The application is the US National Phase of International Application No. PCT/EP2015/000014 having an International Filing Date of 7 Jan. 2015, which claims priority on German Patent Application No. 10 2014 001 082.1 having a filing date of 30 Jan. 2014.

### BACKGROUND OF THE INVENTION

1. Technical Field

The invention relates to a method for producing a thin-walled plastic profile where a continuous reinforcement produced from strands, woven fabric and/or the like is guided through a mold comprising at least one mold core and is embedded in the plastics material in the mold as well as to a device for producing a thin-walled plastic profile having a mold, which comprises at least one mold core, in which a continuous reinforcement of the plastic profile (30) is embedded in liquid plastics material.

2. Prior Art

Plastics material objects, in particular plastic profiles, produced from plastics material and a continuous reinforcement produced from fibers, woven fabrics and/or knitted fabrics, which are embedded in the plastics material, are predominantly produced in a strand. This is usually carried out using the pultrusion method. The reinforcement is guided through a mold for this purpose and the reinforcement is embedded in the mold in liquid plastic which then hardens in the mold.

The hardened plastic profile leaving the mold is pulled through the mold by a take-off device, which is arranged in front of the mold in the pultrusion direction, and at the same time is simultaneously conveyed away. As a result of the plastic profile being pulled through the mold by the take-off device, only plastic profiles which withstand the force or the pressing pressure of the take-off device are able to be formed in the case of known methods of the described type, in particular in the case of known pultrusion methods. Consequently, it has only been possible up to now to produce plastic profiles which comprise sufficient wall thicknesses.

### BRIEF SUMMARY OF THE INVENTION

The object underlying the invention then is to create a method and a device for producing curved and straight thin-walled plastic profiles or hollow profiles.

A method for achieving said object is a method for producing a thin-walled plastic profile where a continuous reinforcement produced from strands, woven fabric and/or the like is guided through a mold comprising at least one mold core and is embedded in the plastics material in the mold, characterized in that at least part of the mold is moved periodically relative to the stationary thin-walled plastic profile, and the thin-walled plastic profile is held by at least one holding means, which comprises a core and an outer holding part, whilst the mold is moved along. Accordingly, it is provided that at least part of a mold is moved periodically relative to the stationary thin-walled plastic profile and the thin-walled plastic profile is held by at least one holding means or gripper, which comprises a core and an outer holding part, whilst the mold is moved along the thin-walled plastic profile, which is stationary relative to the same. The plastic profile is preferably a hollow profile or a tubular profile produced from plastics material of arbitrary cross section. The holding means or the gripper is realized in such a manner that it completely surrounds the thin-walled plastic profile. The holding means preferably comprises at least two outer holding parts which surround the tubular profile in a complete, preferably partial, manner and are arranged about the tubular profile so as to be releasable. The joining together and moving apart of the outer holding parts is effected automatically or manually and is matched to the production process. The core, which is associated with the holding means, is situated in the interior of the plastic profile or of the tubular profile and corresponds in its form to the inside dimensions of the profile. The core of the holding means is fixed by a holding bar, in particular is coupled magnetically in a contactless manner with the holding parts. It is additionally provided according to the invention that the plastic profile hardens during the production process, in particular whilst it is in contact with at least part of the mold and/or is held by the holding means. As an alternative to this, however, it is also conceivable for the plastic profile not to harden, in particular only to harden in part, during the production process, in particular whilst it is in contact with at least part of the mold and/or is held by the holding means. The plastic profile is pulled out of the mold in a non-hardened or not completely hardened state and in a further step outside the mold and the holding means is moved into an end form in which it then hardens completely (pull-forming). In said case, the production is divided into two stages, namely into a pre-forming by the mold and an end forming by a further forming means. The further forming means can be, for example, a press. As a result of dividing the production process into two in this manner, more complex, individualized plastic profiles are able to be produced.

It is provided in the case of a preferred development of the method that the holding means is arranged directly in front of or behind the mold along the thin-walled plastic profile or tubular profile when viewed in a pultrusion direction of the thin-walled plastic profile. The spacing between the holding means and the mold is modified by moving the mold and/or the holding means in an alternating, preferably periodic manner. As a result of said pilgering process, the mold and the holding means are moved alternately or together over the plastic profile, in a direction in opposition to the pultrusion direction, preferably in the pultrusion direction. When seen in the pultrusion direction, the mold and the holding means are arranged in front of a material store. The holding means is preferably positioned in front of the mold and in front of the material store and the mold is positioned behind the holding means. The plastic profile leaves the mold at an outlet area which is associated with a front end of the mold in the pultrusion direction. At an end of the mold located opposite the outlet area is situated an inlet area into which the material is pulled when the profile is being produced. The material gradually passes through the inlet area into the mold and the plastic profile gradually passes out of the outlet area of the mold again. The finished plastic profile is situated in front of the holding means when seen in the pultrusion direction.

It is further provided that the at least one holding means is moved out of contact with the thin-walled plastic profile in phases in which at least part of the mold is stationary, preferably the outer holder of the holding part is moved out of contact with the thin-walled plastic profile, and is moved toward the mold in a direction opposite to a pultrusion direction relative to the stationary plastic profile. In this case, the core of the holding means is moved in the same manner as the outer holder. The relative positioning of the outer holder and of the core of the holding means does not change. The outer holder and the core of the holding means are moved to the same extent with reference to the thin-walled plastic profile.

It is provided according to the invention that the at least one holding means is moved into contact with the thin-walled plastic profile in phases in which at least part of the mold is stationary relative to the thin-walled plastic profile. It is preferably provided that the outer holder of the holding means is moved into contact with the thin-walled plastic profile or the contact is eliminated again. Where they are in contact, a pressure is built up onto an outer wall of the profile. So that the profile does not kink or become damaged, a corresponding counter pressure, which compensates for the force of the holding parts onto the wall, is built up through the core of the holding means which is located in the interior of the profile. The force or the pressing pressure of the holding parts and the counter force of the core are so great that the profile is fixed in such a manner that it is not movable along the pultrusion direction.

It is provided according to a further development of the method that to achieve a starting position of the pultrusion method at least part of the mold and the or each of the holding means, which comprise a core, are moved together with the plastic profile in the pultrusion direction. Said starting position is the start of a new pultrusion cycle. Where the mold, the holding means and the plastic profile are moved together, material for the next pultrusion step is removed from the material store.

It is additionally provided in a preferred manner that that the at least one holding means, which comprises a core, is stationary and is moved out of contact with the thin-walled plastic profile and a front end of the mold is then moved together with the thin-walled plastic profile in the pultrusion direction into the vicinity of the holding means. The thin-walled plastic profile, in this case, is pushed over the core of the holding means. In the case of said alternative method step, the holding means is not moved. The holding parts and the core are still located at the same point and are not moved along the pultrusion direction. Rather, with the holding parts open, the plastic profile is pushed through by the holding means. The spacing between the mold or the outlet area of the mold and the holding means varies periodically between a maximum stroke position and a minimum stroke position. Said method is preferred for plastics materials where the material or the plastics material adheres and an ideal separating means is not present.

In particular, the invention further provides that the core of the holding means is fed through at least part of the mold in the pultrusion direction, specifically to the region of the thin-walled plastic profile which is held by the outer holding part. It is additionally provided that, as an alternative to this, the core of the holding means is fed, in a direction in opposition to the pultrusion direction, to the region of the thin-walled plastic profile which is held by the outer holding part. When the core of the holding means is fed, in opposition to the pultrusion direction, to the outer holding part by the finished thin-wall plastic profile, this must be interrupted at regular portions. When the core of the holding means is fed to the region of the thin-walled plastic profile which is held by the outer holding part, by the mold in the pultrusion direction, the inner part of the mold or of the mold core must be provided in such a manner.

It is provided according to a further development of the invention that a force, which opposes the force which acts onto the thin-walled plastic profile through the outer holding part, is generated by the core, in the interior of the thin-walled plastic profile. In particular, in the case of thin-walled profiles, it is important that the force, which is applied onto the thin-walled plastic profile by the outer holding part, is compensated for by a corresponding counter force. If the force of the outer holding part is not compensated for, this can result in destruction of the thin-walled plastic profile. Consequently, it is essential to the invention that the core of the holding part counters at least the force generated by the outer holding part in the interior of the hollow profile and that the core and the holding parts are always located at the same height with reference to the profile.

It is preferably provided according to the invention that a force corresponding to the force generated by the outer holding part is generated by an expandable core of the holding means. As the core of the holding means is expandable in an arbitrary manner according to the invention, the counter force to the force generated by the outer holding part is variable. The force which counters the outer holding part is thus able to be adjusted in a flexible manner.

It is further provided that the expandable core of the holding means is supplied by a holding bar, which is connected to the core, with a pressurized medium, corresponding to the force generated by the outer holding part. The pressurized medium can preferably be a gas, such as for example air, or a liquid. The pressure of the medium in the core can be varied in an arbitrary manner, in particular the medium can be pumped out of the core completely. The core, which preferably consists of a flexible plastics material, additionally comprises in its interior an expandable bellows in which the pressurized medium is situated.

A further advantageous development of the present invention is that the plastic profile is held alternately by different holding means which are arranged one behind another on the thin-walled plastic profile, whilst the mold or the mold core is moved relative to the stationary thin-walled plastic profile.

It is provided according to the invention that several, preferably two, holding means are arranged in front of the mold. The thin-walled plastic profile is radially profiled when held by at least one holding means. At least one of the holding means is profiled in such a manner that, when contacting the thin-walled plastic profile, it transfers said profiling or a negative of the profiling to the hollow profile. In this case it is provided that the profiling can have both a concave and a convex form. When the profiled holding part interacts with the expandable core, the thin-walled plastic profile can be acted upon individually with a profiling in a localized manner. The form of the expandable core is adapted such that the thin-walled plastic profile is fixed in a positive locking manner between the profiling of the holding means and the core. It is conceivable for a plurality of differently profiled holding parts to be arranged one behind another along the pultrusion direction and to imprint a complex profiling on the thin-walled plastic profile.

A device for achieving the object named in the introduction is a device for producing a thin-walled plastic profile having a mold, which comprises at least one mold core, in which a continuous reinforcement of the plastic profile is embedded in liquid plastics material, characterized in that at least part of the mold is movable relative to the plastic profile along the same and, when viewed in a pultrusion direction, at least one holding means, which comprises a core and an outer holding part, for the plastic profile emerging from the mold is arranged in front of the mold. It is provided that at least part of the mold is movable relative to the plastic profile along the plastic profile and, when viewed in a pultrusion direction, at least one holding means, which comprises a core and an outer holding part, is arranged in front of the mold for holding the plastic profile which emerges out of the mold.

It is further provided in a preferred manner that the respective holding means is realized for producing a releasable grip-type connection to the thin-walled plastic profile or hollow profile outside the mold, in particular in front of the mold when seen in the pultrusion direction, and preferably each holding means is movable relative to the thin-walled plastic profile.

A further advantageous development of the present invention is that the core corresponds in its dimensioning to an inner cross section of the thin-walled plastic profile. It is additionally conceivable for a gap, preferably a narrow gap, to be arranged between the core and an inner wall of the thin-walled plastic profile.

In addition, it is provided in particular that the core of the holding means comprises a holding bar which extends through at least part of the mold in the pultrusion direction, or extends through the thin-walled plastic profile in a direction in opposition to the pultrusion direction.

The invention further provides that the core consists of a flexible material, preferably a plastics material which is variable in size as a result of a medium, preferably a gas or a liquid, via a feed line in the holding bar. The device has associated therewith a pump which pumps gas or a liquid into the core or out of the core depending on the production phase. A bellows, which is produced from a flexible material and is connected to the feed line, is situated in the interior of the core. The gas or the liquid flows or runs into said bellows. The expanding bellows presses against the flexible material of the core, as a result of which the counter pressure or the counter force to the force generated by the outer holding part is generated.

It is further provided according to the invention that the flexible core of the holding means is adaptable to the form of the holding parts and is movable along the pultrusion direction through the holding bar in such a manner that different positions are actuatable in order to support the outer holding parts. In particular, where there are multiple holding means arranged one behind another it is essential that the core can be associated with the holding means holding the thin-walled plastic profile.

It is provided according to the invention in particular that, when viewed in the pultrusion direction, two or more holding means are arranged in front of the mold, wherein at least one holding means comprises a profiled holding part and the holding means are operable independently of one another. It is provided in particular that the holding means are operable coupled together.

### BRIEF DESCRIPTION OF THE DRAWINGS

Preferred exemplary embodiments of the invention are explained in more detail below by way of the drawing, in which:

FIG. 1 shows a schematic view of a first exemplary embodiment of a device according to the invention in a starting position,

FIG. 2 shows a schematic view of a second exemplary embodiment of a device according to the invention in a starting position,

FIG. 3 shows the device of FIG. 1 after a first operating step which follows the starting position,

FIG. 4 shows the device of FIGS. 1 and 3 after a second operating step,

FIG. 5 shows the device of FIGS. 1, 3 and 4 after a third operating step,

FIG. 6 shows the device of FIGS. 1, 3 to 5 after a last operating step,

FIG. 7 shows a second method example of a device according to the invention of FIG. 1 in a starting position,

FIG. 8 shows the device of FIGS. 1 and 7 after a first operating step,

FIG. 9 shows the device of FIGS. 1, 7 and 8 after a second operating step,

FIG. 10 shows the device of FIGS. 1, 7 to 9 after a third operating step,

FIG. 11 shows the device of FIGS. 1, 7 to 10 after a fourth operating step,

FIG. 12 shows FIGS. 1, 7 to 11 after the last operating step,

FIG. 13 shows a schematic view of a further exemplary embodiment of a device according to the invention,

FIG. 14 shows the device of FIG. 13 after a further operating step,

FIG. 15 shows a schematic view of a further exemplary embodiment of a device according to the invention in a starting position,

FIG. 16 shows the device of FIG. 15 after a first operating step which follows the starting position,

FIG. 17 shows the device of FIGS. 15 and 16 after a second operating step,

FIG. 18 shows the device of FIGS. 15 to 17 after a third operating step,

FIG. 19 shows the device of FIGS. 15 to 18 after a fourth operating step and

FIG. 20 shows the device of FIGS. 15 to 19 in a last operating step.

### DETAILED DESCRIPTION OF PREFERRED EMBODIMENTS

The figures show schematic representations of the devices according to the invention which also serve for carrying out the method according to the invention. Said devices are pultrusion devices for producing plastic profiles 30, in particular thin-walled plastic profiles, preferably tubular plastic profiles. The plastics material is preferably a thermosetting plastics material.

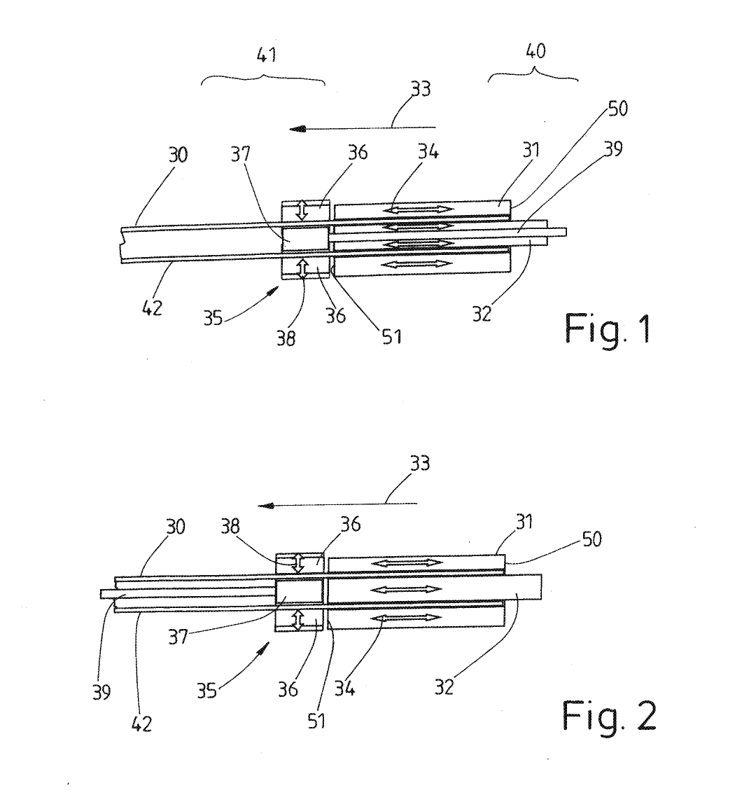

Tubular plastic profiles 30 with arbitrary wall thicknesses are able to be produced using the schematically shown devices. The device shown in FIG. 1 shows a mold 31 with a mold core 32 located therein which, as a result of their interaction, impart its tubular development to the plastic profile 30. The invention is not limited to the plastic profile 30 only comprising one mold core 32, rather it is also conceivable for the plastic profile 30 to comprise a more complex cross section which is produced with a plurality of mold cores 32. The mold 31 and the mold core 32 can be moved parallel to a pultrusion direction 33 over or through the plastic profile 30 (indicated by arrows 34).

When viewed in the pultrusion direction 33, a holding means 35 (FIG. 1) is situated in front of the mold 31 or in front of the mold core 32. Said holding means 35 comprises an outer holding part 36 and a core 37. The outer holding part 36 preferably consists of two parts and can be closed from the outside about the plastic profile 30 which emerges out of the mold 31. By moving the outer holding parts 36 transversely with respect to the pultrusion direction 33 (indicated by arrows 38), the plastic profile 30 is able to be gripped, or released. With the outer holding parts 36 in the same position relative to the plastic profile 30, the core 37 of the holding means 35 is situated in the interior of the plastic profile 30. The diameter of the core 37 is dimensioned in such a manner that it corresponds precisely to the inside cross section of the plastic profile 30. However, it is also conceivable for the outside diameter of the core 37 to be reduced slightly in relation to the cross section of the plastic profile 30. The length of the core 37 corresponds to the length of the outer holding parts 36.

The core 37 is movable parallel to the pultrusion direction 33 by means of a holding bar 39 in the plastic profile 30. In the case of the exemplary embodiment of the invention shown in FIG. 1, the holding bar 39 extends through the mold core 32. This is possible if the mold core 32 has a corresponding development.

A material store (not shown) for fibers, for example carbon fibers, woven fabric and/or knitted fabric or similar or for reinforcement is situated behind the mold 31 in a direction in opposition to the pultrusion direction 33. Consequently, the fibers, woven fabric, the reinforcement, etc., are pulled into the mold 31 or the mold core 32 in a rear region 40 and leave said mold core again in a front region 41 where the molded plastic profile is gripped by the holding means 35. This means the fibers etc., are pulled into the mold through the inlet area 50 of the mold 31 and leave the mold 31 again out of an outlet area 51. The mold 31 can be heatable and/or coolable for more rapid hardening of the profile.

If the nature of the mold core 32 does not allow the holding bar 39 to extend through the mold core 32 in the pultrusion direction 33, the core 37 is held by the holding bar 39 from the front region 41 in a direction in opposition to the pultrusion direction 33 (FIG. 2). Here, the holding bar 39 extends through the interior of the finished plastic profile 30.

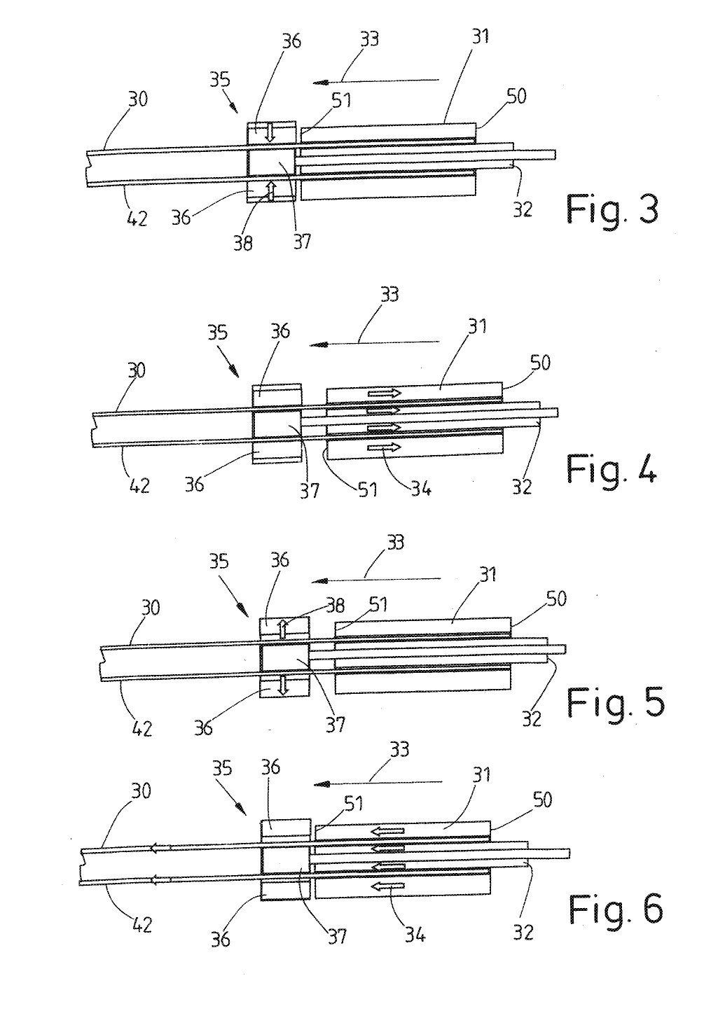

The production of a thin-walled plastic profile 30 with the device according to FIG. 1 is shown below by way of FIGS. 3 to 6. Said production of a thin-walled plastic profile 30, which is described in FIGS. 3 to 6, can be transferred to the device according to FIG. 2. In the phase of the production of a thin-walled plastic profile 30 shown in FIG. 3, the outer holding parts 36 are moved in such a manner transversely with respect to the pultrusion direction 33 (indicated by the arrows 38) that they come into contact with the outer wall 42 of the plastic profile 30. The plastic profile 30 is gripped in such a manner by the outer holding parts 36 that the plastic profile 30 is secured fixedly between the outer holding parts 36 and the core 37 of the holding means 35.

When the plastic profile 30 is secured between the outer holding part 36 and the core 37, the mold 31 and the mold core 32 are moved along the plastic profile 30 in a direction in opposition to the pultrusion direction 33 and in this case pull fibers, woven fabric, reinforcement, knitted fabric etc. (not shown) into the inlet area 50 of the mold 31 (34) (FIG. 4). The wall 42 of the tubular plastic profile 30 is formed at the same time. The most varied hollow-walled or tubular plastic profiles can be produced in this manner depending on the development of the mold 31 and of the mold core 32.

Once the mold 31 and the mold core 32 have covered a certain distance along the plastic profile 30, the mold 31 or the mold core 32 stop (FIG. 5). The holding means 35 then releases the plastic profile 30 by the outer holding parts 36 moving outward (indicated by the arrows 38) (FIG. 5).

In the last operating step, the plastic profile 30 is moved together with the mold 31 and the mold core 32 in the pultrusion direction 33 such that the mold 31 or the mold core 32 are once again in the vicinity of the holding means 35. The plastic profile 30 together with the mold 31 and the mold core 32 are moved, in this case, parallel to the pultrusion direction 33 relative to the holding means 35 (FIG. 6). The plastic profile 30, the mold 31 and the mold core 32 are stationary relative to one another in the case of said operating step. When the plastic profile 30 is moved, further material is removed from the material store (not shown). The method described in FIGS. 3 to 6 for producing a thin-walled profile is suitable in particular for adhesive profiles.

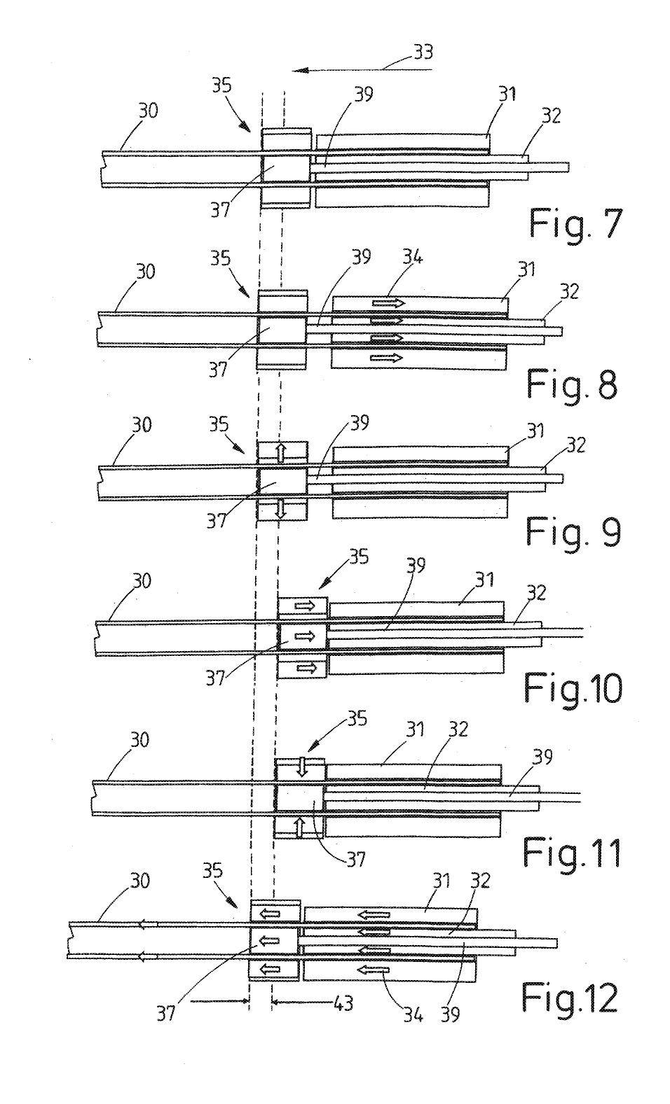

FIGS. 7 to 12 show a further exemplary embodiment of the present invention. The method shown in FIGS. 7 to 12 is described by way of the exemplary embodiment of the device according to FIG. 1. It can easily be transferred however, to the exemplary embodiment according to FIG. 2. The method described in FIGS. 7 to 12 for the production of a thin-walled plastic profile is suitable in particular for ideal separating means, this means the fibers or the profile do not stick in the mold.

FIG. 7 describes a starting position according to FIG. 1. The method shown in FIGS. 7 to 9 is identical to the sequences in FIGS. 3 to 5. Consequently, reference is made to the above description.

Once the mold 31 and the mold core 32 have formed the plastic profile 30 and the holding means 35 has opened (FIG. 9), the outer holding part 36 and the core 37 move together in a direction in opposition to the pultrusion direction 33 toward the mold 31 or the mold core 32. The distance which the mold 31 or the mold core 32 covers over the plastic profile 30 corresponds to the distance which has been covered by the mold 31 or the mold core 32 for the production of the plastic profile 30 (FIG. 10).

Once the holding means 35 has moved along the plastic profile 30 in a direction in opposition to the pultrusion direction 33, the holding means 35 with its outer holding part 36 closes about the plastic profile 30 again (FIG. 11). The plastic profile 30 is now fixedly gripped by the outer holding part 36 and the core 37.

In the next and last operating step, the holding part 35, the mold 31, the mold core 32 and the plastic profile 30 are moved together in the pultrusion direction 33, by precisely one stroke 43 which the holding means 35, the mold 31 and the mold core 32 have carried out beforehand in a direction in opposition to the pultrusion direction 33 (FIG. 12); they are once again accordingly situated in their starting position shown in FIG. 7. The plastic profile 30 is pulled by the holding means 35 during said movement. In the case of the last operating step (FIG. 12), the plastic profile 30, the holding means 35, the mold 31 and the mold core 32 are moved relative to the material store (not shown).

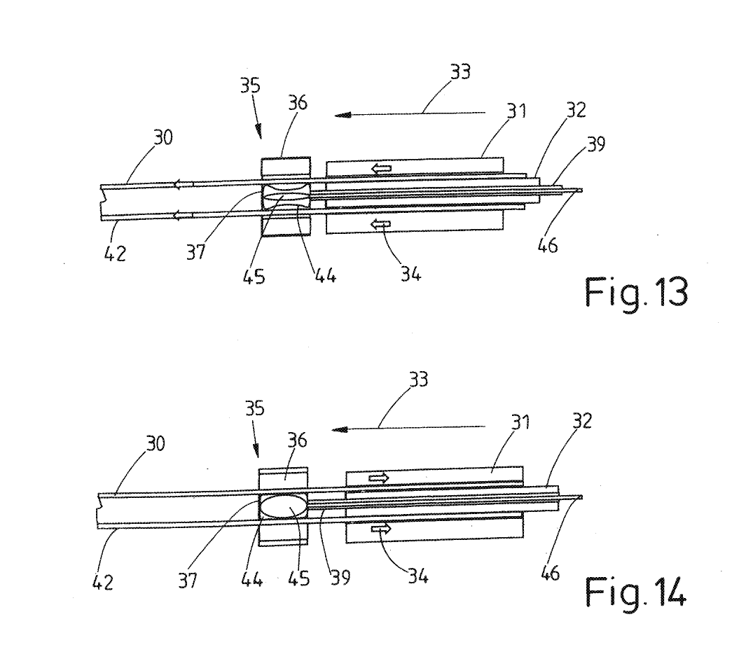

A further exemplary embodiment of the invention is shown in FIGS. 13 and 14. In the case of said exemplary embodiment, the core 37 of the holding means 35 is realized in a flexible manner. The core 37 comprises a flexible outer covering 44, the form of which can be changed in an arbitrary manner. A bellows 45 is situated in the interior of the outer covering 44. Said bellows 45 is connected to a line 46. Said line extends through the holding bar 39 and is connected to a pump which is not shown. A liquid or a gas is pumpable into the bellows 45 via said line 46. When a gas or a liquid is pumped into the bellows 45, the bellows 45 expands and transfers its outer form to the more solid outer covering 44 of the core 37. Depending on the nature of the cross section of the plastic profile 30, the form of the core 37 can thus be adapted as a result of expanding the bellows 45 or the outer covering 44. In the phase of producing the thin-walled plastic profile 30, in which the holding means 35 fixedly surrounds the plastic profile 30 (FIG. 3, FIG. 11), the outer holding part 36 consequently presses from the outside onto the wall 42 of the plastic profile and the expanded core 37 from the interior of the plastic profile 30 (FIG. 14). The core 37 or the covering 44 or the bellows 45 can also be contracted again. It is advantageous particularly for the movement of the core 37 relative to the plastic profile 30 when the core 37 is contracted. The contraction of the core 37 can also be managed by means of the pump means (not shown). In this case, the gas or the liquid is pumped out of the bellows 45. All further operating steps for producing the thin-walled plastic profile 30 run according to FIG. 3 to 6 or 7 to 12.

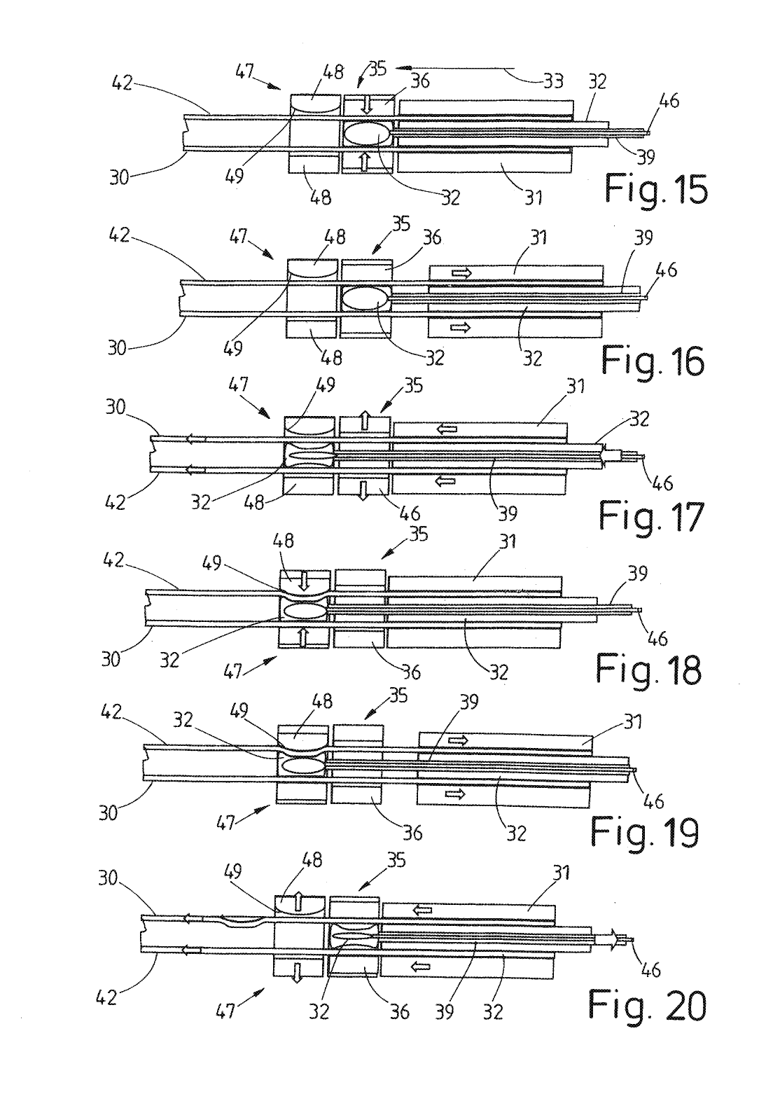

A further embodiment of the present invention is shown in FIGS. 15 to 20. The device shown in FIG. 15 for producing a thin-walled plastic profile 30, along with the previously described holding means 35, comprises a further second holding means 47. A single common core 37 is associated with the holding means 35 and the second holding means 47. The core which is common to the holding means 35 and 47 is realized according to the core described in FIGS. 13 and 14, as an expanding or contracting flexible core. It is provided according to the invention that at least one outer holding part 48 of the second holding means 47 comprises a concave or convex or arbitrary form on the side of the plastic profile. This means that the form of the outer holding part 48 of the second holding means 47 does not correspond to the form of the outer wall 42 of the plastic profile 30. In the case of the exemplary embodiment shown in FIG. 15, the outer holding part 48 of the second holding means 47 comprises a convex profiling 49.

The method for producing a thin-walled plastic profile shown in FIGS. 15 and 16 corresponds to the method in FIGS. 3 to 6 with the exemplary embodiment of FIGS. 13 and 14. When the mold 31 and the mold core 32 and the plastic profile 30 are moved in the pultrusion direction 33 and when the holding means 35 is open, the core 37 is moved along the pultrusion direction 33 by the holding bar 39. The core 37 is moved in a contracted state in such a manner along the pultrusion direction 33 that it corresponds in its position to the second holding means 47 (FIG. 17).

For the following pultrusion step, the second holding means 47 and the core 37 move into a starting position (FIG. 18). In this connection, the plastic profile 30 is gripped by the second holding means 47. The plastic profile 30 is deformed locally as a result of the profiling 49 of the outer holding part 48. So that the plastic profile 30 is able to be held by the second holding means 47 even in the case of said local deformation, the flexible core 37 is inflated in such a manner that it corresponds to the profiling of the plastic profile 30 which was brought about by the second holding means 47. In this way, the plastic profile 30 can be fixed by the second holding means 47 even with said local deformation and protected from an unwanted movement in a direction in opposition to the pultrusion direction 33 (FIG. 19).

Once the mold 31 or the mold core 32 has finished a new portion of the plastic profile 33, the second holding means 47 is opened again and the contracted core 37 is fed to the holding means 35 in a direction in opposition to the pultrusion direction 33 (FIG. 20).

It is provided for all embodiments for the production of the plastic profile 30 that the profile 30 hardens in the mold 31 and/or in the holding means 35. Hardening in the mold 31 is advantageous insofar as the plastic profile 30 cannot be deformed any more by the holding means 35. However, it is also provided for all embodiments that the plastic profile 30 hardens outside the mold 31 or the holding means 35. Consequently, no hardening or only partial hardening takes place in the mold 31. As a result of the plastic profile 30 not yet being fully hardened, it can be moved into an end form (pull forming) as a result of a further forming means, such as a press (not shown). The plastic profile 30 then hardens completely in said end form state.

The method for producing a thin-walled plastic profile is not fixed to the embodiment in FIGS. 15 to 20. Rather, it is provided according to the invention that a plurality of outer holding means is assigned to the plastic profile 30, it being possible for each holding means to have an individual profiling. It is also possible to vary the sequence of the holding means to be used as a result of the arbitrarily expandable or contractible core.

### LIST OF REFERENCES

30 Plastic profile
31 Mold
32 Mold core
33 Pultrusion direction
34 Arrow
35 Holding means
36 Outer holding part
37 Core
38 Arrow
39 Holding bar
40 Rear region
41 Front region
42 Wall
43 Stroke
44 Covering
45 Bellows
46 Line
47 Second holding means
48 Outer holding part
49 Profiling
50 Inlet area
51 Outlet area

1. A method for producing a thin-walled plastic profile (30) wherein:
a continuous reinforcement produced from strands, woven fabric and/or the like is guided through a mold (31) comprising at least one mold core (32) and is embedded in the plastics material in the mold (31),
at least part of the mold (31) is moved periodically relative to the stationary thin-walled plastic profile (30), and
the thin-walled plastic profile (30) is held by at least one holding means (35), which comprises a core (37) and an outer holding part (36), whilst the mold (31) is moved along.

2. The method as claimed in claim 1, wherein the holding means (35) is arranged directly in front of or behind the mold (31) along the thin-walled plastic profile (30) when viewed in a pultrusion direction (33) of the thin-walled plastic profile (30), wherein the spacing between the holding means (35) and the mold (31) is modified by moving the mold (31) and/or the holding means (35) in an alternating, preferably periodic manner.

3. The method as claimed in claim 1, wherein the at least one holding means (35) is moved out of contact with the thin-walled plastic profile (30) in phases in which at least part of the mold (31) is stationary relative to the plastic profile (30), preferably the outer holding parts (36) of the holding means (35) are moved out of contact with the thin-walled plastic profile (30), and is moved to the mold (31) relative to the stationary plastic profile (30) in a direction in opposition to a pultrusion direction (33).

4. The method as claimed in claim 1, wherein the at least one holding means (35) is moved into contact with the thin-walled plastic profile (30) in phases in which at least part of the mold (31) is stationary relative to the thin-walled plastic profile (30), preferably the outer holder of the holding means (35) is moved into contact with the thin-walled plastic profile (30).

5. The method as claimed in claim 1, wherein to achieve a starting position, at least part of the mold (31) and each of the holding means (35) are moved together with the plastic profile (30) in the pultrusion direction (33).

6. The method as claimed in claim 1, wherein the at least one holding means (35), which comprises a core (31), is stationary and is moved out of contact with the thin-walled plastic profile (30) and an outlet area (51) of the mold (31) is moved together with the thin-walled plastic profile (30) in the pultrusion direction (33) into the vicinity of the holding means (35).

7. The method as claimed in claim 1, wherein the core (37) of the holding means (35) is fed in the pultrusion direction (33) through at least part of the mold (31) to the region of the thin-walled plastic profile (30), which is held by the outer holding part (36), preferably is fed to the region of the thin-walled plastic profile (30), which is held by the outer holding part (36), in a direction in opposition to the pultrusion direction (33).

8. The method as claimed in claim 1, wherein a force which opposes the force which acts onto a wall (42) of the thin-walled plastic profile (30) through the outer holding part (36) is generated by the core (31), preferably fixed core (31), in the interior of the thin-walled plastic profile (30).

9. The method as claimed in claim 1, wherein a force corresponding to the force generated by the outer holding part (36) is generated preferably in variable manner by an expandable core (37) of the holding means (35).

10. The method as claimed in claim 1, wherein the expandable core (37) of the holding means (35) is supplied by means of a holding bar (39), which is connected to the core (37), with a pressurized medium, preferably a gas or a liquid, corresponding to the force generated by the outer holding part (36).

11. The method as claimed in claim 8, wherein the thin-walled plastic profile (30), which is moved periodically in and in opposition to the pultrusion direction (33), is held by different holding means (35) one after another which are arranged one behind another along the thin-walled plastic profile (30) and the wall (42) of the thin-walled plastic profile (30) is profiled in a radial manner by at least one holding means (35).

12. A device for producing a thin-walled plastic profile (30) having a mold (31), which comprises at least one mold core (32), in which a continuous reinforcement of the plastic profile (30) is embedded in liquid plastics material, wherein at least part of the mold (31) is movable relative to the plastic profile (30) along the same and, when viewed in a pultrusion direction (33), at least one holding means (35), which comprises a core (37) and an outer holding part (36), for the plastic profile (30) emerging from the mold (31) is arranged in front of the mold (31).

13. The device as claimed in claim 12, wherein the respective holding means (35) is realized for producing a releasable grip-type connection to the thin-walled plastic profile (30) outside the mold (31), in particular in front of the mold (31), and preferably each holding means (35) is movable relative to the thin-walled plastic profile (30) along the pultrusion direction (33).

14. The device as claimed in claim 12, wherein the core (37) corresponds in its dimensioning to an inner cross section of the thin-walled plastic profile (30), a narrow gap is arranged in particular between the core (37) and an inner wall of the thin-walled plastic profile (30).

15. The device as claimed in claim 12, wherein the core (37) of the holding means (35) comprises a holding bar (39) which extends through at least part of the mold (31) in the pultrusion direction (33), or extends through the thin-walled plastic profile (30) in a direction in opposition to the pultrusion direction (33).

16. The device as claimed in claim 15, wherein the core (37) consists of a flexible material, preferably a plastics material, which is variable in size as a result of a medium, preferably a gas or a liquid, via a feed line (46) in the holding bar (39).

17. The device as claimed in claim 12, wherein the flexible core (37) of the holding means (35) is adaptable to the profiled holding parts (36) and is movable along the pultrusion direction (33) through the holding bar (39) in such a manner that it is able to support different outer holding parts (36).

18. The device as claimed in claim 12, wherein, when viewed in the pultrusion direction (33), two or more holding means (35) are arranged in front of the mold (31), wherein at least one holding means (35) comprises a profiled holding part (36) and the holding means (35) are operable independently of one another.
